(19) United States
(12) Patent Application Publication
(10) Pub. No.: US 2015/0144692 A1
(43) Pub. Date: May 28, 2015

(54) SYSTEM AND METHOD FOR INDICIA READING AND VERIFICATION

(71) Applicant: Hand Held Products, Inc., Fort Mill, SC (US)

(72) Inventor: Benjamin Hejl, Cherry Hill, NJ (US)

(21) Appl. No.: 14/087,190

(22) Filed: Nov. 22, 2013

(51) Int. Cl. G06K 5/00

(52) U.S. Cl. CPC G06K 5/00
USPC 235/437

(57) ABSTRACT

An indicia-reading system and indicia-verification method are provided. The indicia-reading system includes an indicia-capturing subsystem for acquiring information about indicia within the indicia-capturing subsystem's field of view. The system also includes an indicia-decoding subsystem for decoding indicia information. A verification subsystem evaluates the quality of the indicia information and generates user feedback regarding the quality of the indicia information.

### FIELD OF THE INVENTION

The present invention relates to indicia readers, such as barcode readers. More specifically, the present invention relates to a system and method for indicia reading and verification.

### BACKGROUND

Indicia readers, such as barcode scanners, are typically configured to acquire information from indicia (e.g., barcodes) and then decode that information for use in information systems. Businesses, in particular, have come to rely on indicia readers for efficient and reliable data entry. For example, indicia readers are frequently employed in retail stores at the point of sale to enable fast and accurate entry of pricing information into the cash register system.

Because information systems have grown so dependent upon indicia readers for data entry, the integrity of these systems relies in great part upon the accuracy of the data encoded by the indicia. Poor quality indicia can lead to costly and time-consuming mistakes. For example, printing defects can cause light spots (e.g., voids) in areas of a barcode that are supposed to be dark. This can result in the indicia reader mistakenly interpreting the defective area as being a light area instead of a dark area, thereby resulting in a data error.

Because of the importance of reliable data entry, and because of the significant harm that can result from indicia having poor quality, industries typically enforce minimum quality standards for indicia. During the 1980s, for example, an ANSI/ISO grading structure was established for barcode print quality. Barcode verifiers are devices that have been developed to analyze the quality of barcodes and ensure compliance with minimum quality standards. Barcode verifiers can be used in various settings, but are frequently used by the barcode creator to ensure that the printed barcodes comply with minimum specifications.

Although barcode verifiers effectively evaluate the quality of indicia such as barcodes, reliance on these verification devices does have drawbacks. These devices tend to be expensive. In part due to their significant cost, businesses may not be able to invest in enough barcode verifiers to have them placed at all locations where they are needed. This can result in delays in verification or in the neglecting of verification. Furthermore, businesses that use a barcode verifier may have the verifier in a physical location that is not readily accessible in all necessary instances. Ensuring that verification technology is available at all locations where barcode scanning is being conducted would improve a business' ability to verify that barcodes are being properly created and scanned.

Therefore, a need exists for an indicia reader that has the capability of verifying the quality of indicia. Combining indicia-reading and verification capabilities into one device would ensure that verification can be conducted at all locations where indicia readers are being used.

### SUMMARY

Accordingly, in one aspect, the present invention embraces an indicia-reading system. The indicia reading system includes an indicia-capturing subsystem. The indicia-capturing subsystem acquires information about indicia within the indicia-capturing subsystem's field of view. The indicia-reading system also includes an indicia-decoding subsystem. The indicia-decoding subsystem is configured for decoding indicia information within the indicia-capturing subsystem's field of view. The indicia-reading system also includes a verification subsystem. The verification subsystem evaluates the quality of the indicia information and generates user feedback regarding the quality of the indicia information.

In an exemplary embodiment, the user feedback comprises information about the physical characteristics of the indicia.

In another exemplary embodiment, the user feedback comprises a recommendation regarding positioning of the indicia-reading system vis-à-vis the indicia.

In yet another exemplary embodiment, the indicia-capturing subsystem is configured to acquire information about barcode symbols within the indicia-capturing subsystem's field of view.

In yet another exemplary embodiment, the indicia-capturing subsystem is an imaging subsystem for capturing images within the imaging subsystem's field of view.

In yet another exemplary embodiment, the indicia information includes a digital image of indicia.

In yet another exemplary embodiment, the indicia-capturing subsystem is a laser scanning subsystem for scanning indicia within the laser scanning subsystem's field of view.

In yet another exemplary embodiment, the indicia-capturing subsystem includes a laser source for projecting laser light toward indicia, and a photodiode for collecting laser light reflected from the indicia.

In yet another exemplary embodiment, the indicia-decoding subsystem includes a signal processor.

In yet another exemplary embodiment, the verification subsystem comprises a speaker for providing user feedback in the form of an aural signal.

In yet another exemplary embodiment, the verification subsystem comprises a display screen for providing user feedback via a graphical cue.

In another aspect, the present invention embraces an indicia-verification method. Information about indicia is acquired. The acquired indicia information is decoded. The quality of the indicia information is evaluated. User feedback regarding the quality of the indicia information is generated.

In an exemplary embodiment, the user feedback comprises information about the density of the indicia.

In another exemplary embodiment, the user feedback comprises information about the print quality of the indicia.

In yet another exemplary embodiment, the user feedback comprises a recommendation regarding the positioning of the indicia with respect to an indicia-reading system.

In yet another exemplary embodiment, the user feedback comprises a recommendation regarding orientation of the indicia with respect to an indicia-reading system.

In yet another exemplary embodiment, the user feedback comprises an aural signal.

In yet another exemplary embodiment, the user feedback comprises a graphical cue.

In yet another exemplary embodiment, the indicia information comprises a digital image of the indicia.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 is a block diagram illustrating an exemplary indicia-reading system according to the present invention.

FIG. 2 is a block diagram illustrating a first alternative embodiment of an exemplary indicia-reading system according to the present invention.

FIG. 3 is a block diagram illustrating a second alternative embodiment of an exemplary indicia-reading system according to the present invention.

FIG. 4 is a block diagram illustrating an exemplary indicia-verification method according to the present invention.

### DETAILED DESCRIPTION

The present invention embraces an indicia-reading system. As used in this disclosure, the term indicia is intended to refer broadly to various types of machine-readable indicia, including barcodes, QR codes, matrix codes, 1D codes, and 2D codes, RFID tags, near-field communication smartchips, machine-readable characters, etc. The indicia are typically graphical representations of information (e.g., data) such as product numbers, package tracking numbers, or personnel identification numbers. The use of indicia readers to input data into a system, rather than manual data entry, results in generally faster and more reliable data entry. The indicia-reading system according to the present invention may embrace various kinds of devices used to read indicia, such as handheld barcode scanners, fixed-position omni-directional barcode scanners, pen-type readers, laser scanners, CCD readers, imaging scanners, and mobile devices like smartphones that are equipped to read indicia, and similar devices.

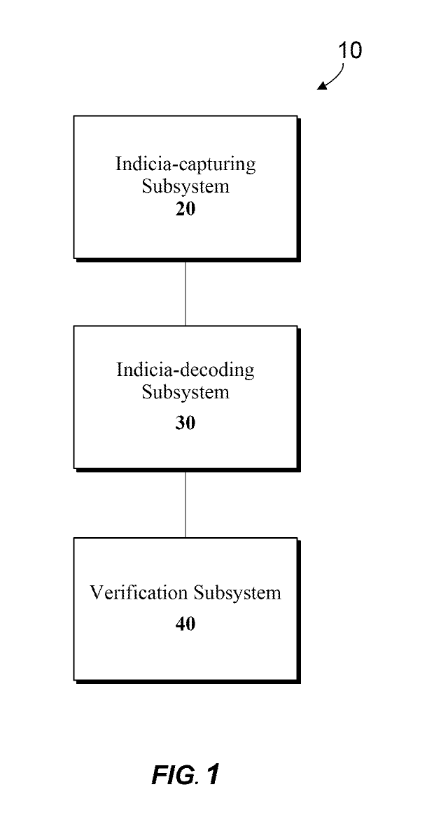

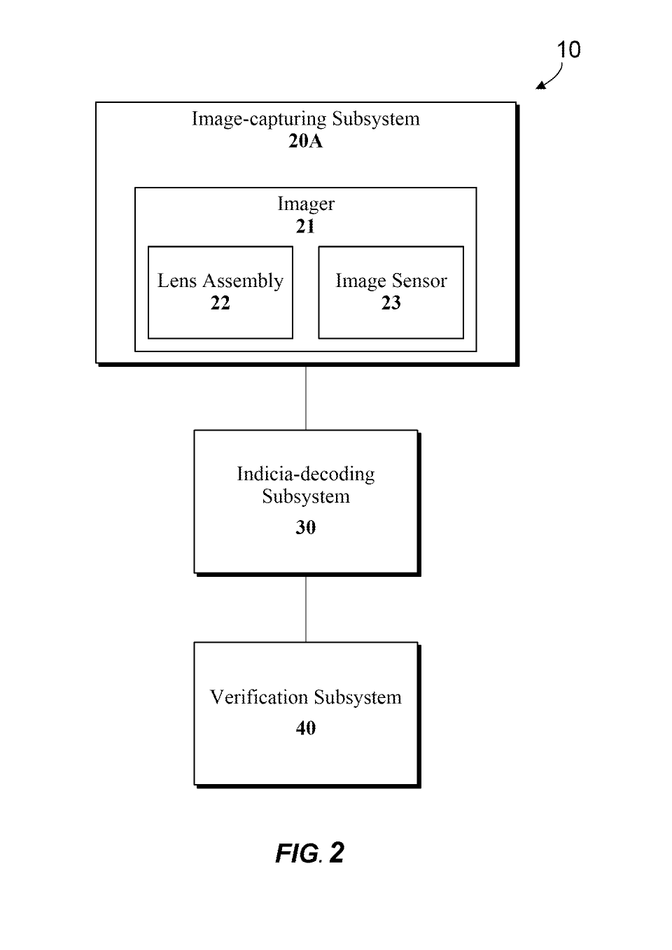

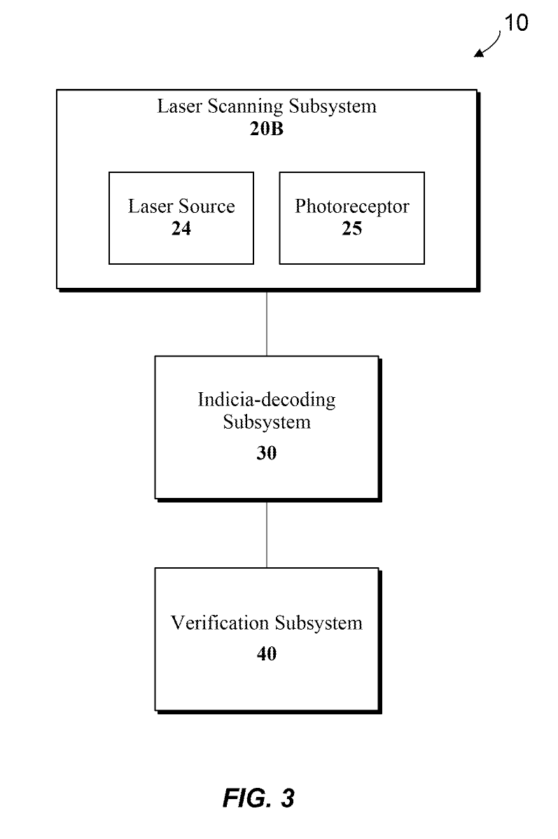

Referring now to FIGS. 1 through 3, the indicia-reading system 10 according to the present invention includes an indicia-capturing subsystem 20. The indicia-capturing subsystem 20 acquires information about indicia within the indicia-capturing subsystem's field of view. Typically, the indicia-capturing subsystem may be an image-capturing subsystem 20A. The image-capturing subsystem 20A typically includes an imager 21 for acquiring indicia information in the form of a digital image of indicia within the imager's field of view. The imager 21 may be a digital camera that includes a lens assembly 22 for focusing light onto an image sensor 23 such as a charged-couple device (CCD) or complementary metal-oxide-semiconductor (CMOS) image sensor. The image sensor 23 converts the optical signal received through the lens assembly 22 into a digital signal capable of being processed by the indicia-reading system 10.

Alternatively, the indicia-capturing subsystem 20 may be a laser-scanning subsystem 20B. The laser-scanning subsystem 20B typically includes a laser source 24 for projecting a laser beam onto the indicia within the laser-scanning subsystem's field of view. The laser beam is typically swept back and forth along a sweep angle within the laser-scanning subsystem's field of view. The laser-scanning subsystem also typically includes a photoreceptor 25 (e.g., photodiode) for receiving indicia information in the form of an optical signal and converting it into indicia information in the form of an electrical signal. As the laser beam is projected into the field of view of the laser-scanning subsystem 20B, the laser beam reflects off the indicia. The photoreceptor 25 receives the reflected laser beam and converts the laser beam optical signal into an electrical signal for processing by the indicia-reading system 10. In the case of a barcode, for example, the photoreceptor 25 measures the intensity of the laser light reflected back from the barcode as the laser beam crosses each bar and space in the printed barcode. Because the dark bars of the barcode absorb light, the reflected optical signal received by the photoreceptor from the darker areas has less intensity. Because the light bars of the barcode reflect light, the reflected optical signal received by the photoreceptor from the white areas has greater intensity. The photoreceptor 25 generates an electrical signal waveform that is used to measure the widths of the dark bars and white spaces in the barcode.

The indicia-reading system 10 according to the present invention also includes an indicia-decoding subsystem 30. The indicia-decoding subsystem 30 is configured for decoding the indicia information received from the indicia-capturing subsystem 20. Where the indicia-capturing subsystem 20 is an image-capturing subsystem 20A, the indicia-decoding subsystem 30 is configured for receiving and decoding indicia information in the form of a digital image of the indicia. Typically, the indicia-decoding subsystem 30 utilizes image processing software to identify the indicia within the digital image and then to decode the indicia. Typically, the image processing software is stored on a computer-readable storage medium (e.g., computer memory) and is executed by a central processing unit (CPU).

Where the indicia-capturing subsystem 20 is a laser-scanning subsystem 20B, the indicia-decoding subsystem 30 receives indicia information in the form of an electrical signal from the photoreceptor 25 of the laser-scanning subsystem 20B. The indicia-decoding subsystem 30 typically employs a signal processor in the decoding of the electrical signal to representing the information encoded by the indicia.

The indicia-reading subsystem 10 also includes a verification subsystem 40. The verification subsystem 40 evaluates the quality of the indicia information and generates user feedback regarding the quality of the indicia information.

The evaluation of the quality of the indicia information by the verification subsystem 40 falls into two broad categories. First, the analysis may focus on obtaining information about the physical characteristics of the indicia. Generally, the verification subsystem 40 evaluates the physical characteristics of the indicia based upon standards promulgated by the International Standards Organization (ISO) and the American National Standards Institute (ANSI). The physical characteristics of the indicia that may be evaluated by the verification subsystem 40 include edge determination, minimum reflectance, symbol contrast, minimum edge contrast, modulation, printing defects, quiet zone, and decodability.

In evaluating edge determination, the verification subsystem 40 detects, in the case of a barcode, for example, whether the appropriate number of bars and spaces are present. A test of the minimum reflectance examines the difference in reflectance between the darkest bar and the background (usually white). For example, the verification subsystem 40 may require that the darkest bar have a reflectance that is less than half of the background reflectance. Symbol contrast evaluates the color contrast between the darkest bars and the whitest spaces. Higher contrast is desirable to allow the indicia-reading system 10 to more easily distinguish between dark bars and white spaces. If the verification subsystem 40 determines that the contrast is too low, it may provide user feedback indicating that not enough ink was used to print the dark areas or that the ink was not dark enough. A modulation test may reveal problems involving ink spread, where the ink bleeds from dark areas into light areas. If a modulation problem is detected, the verification subsystem 40 may provide user feedback indicating that the inking process may need to be modified. The verification subsystem 40 may identify printing defects that generally fall into one of two categories: voids and spots. Voids are light areas within dark bars. Spots are dark areas in the white spaces. These types of printing defects can lead to decoding areas when the indicia-decoding subsystem 30 mistakenly identifies a dark bar as a white space due to the presence of a void. When the verification subsystem 40 detects the presence of voids, it may provide user feedback indicating that more ink should be used in printing the dark areas. The verification subsystem 40 may also evaluate if the indicia information reveals that the indicia complies with quiet zone requirements. Standards for the creation of UPC symbols, for example, require that the UPC symbol have a quiet zone, or area of uniform light contrast, adjacent to the outer edges of the left and right guard bars. If the verification subsystem 40 determines, based on the indicia information, that the indicia does not have a required quiet zone, the verification subsystem 40 may provide user feedback indicating, for example, that the indicia-maker should ensure that no printing was added in the quiet zone following the creation of the indicia. The verification subsystem 40 may also obtain from the indicia-decoding subsystem 30 a determination of whether or not the indicia was decoded successfully. If the decoding was not successful but the verification subsystem 40 determines that all physical attributes of the indicia are within acceptable parameters, then the verification subsystem 40 may provide user feedback indicating that the indicia was not properly encoded.

Second, the quality evaluation performed by the verification subsystem 40 may analyze manner of acquiring the indicia information. For example, the verification subsystem 40 may analyze the positioning of the indicia with respect to the indicia-reading system 10. If, based upon an analysis of the indicia information (e.g., digital image), the verification subsystem 40 determines that decoding of the indicia could be performed more easily by modifying the positioning of the indicia with respect to the indicia-reading system 10, then the verification subsystem 40 may provide user feedback indicating that the user should reposition the indicia. Typically, the repositioning user feedback will indicate that the indicia was either too close to, or too far from, the indicia-capturing subsystem 20 when the indicia information was acquired. The verification subsystem 40 may generate user feedback indicating that the indicia should be closer to, or farther from, the indicia-capturing subsystem 20 when the indicia is scanned or imaged. By way of further example, the verification subsystem 40 may analyze the orientation of the indicia with respect to the indicia-reading system 10. If the verification subsystem 40 determines that the orientation is not conducive to efficient decoding of the indicia, the verification subsystem 40 may provide user feedback indicating that the orientation should be changed. For example, the verification subsystem 40 might determine that the indicia information (e.g., digital image) was acquired while the indicia was at an extremely skewed angle with respect to the indicia-capturing subsystem 20. The user feedback may provide instruction that the indicia-decoding system 10 be reoriented. It will be appreciated that re-orientation or repositioning may involve moving the indicia, the indicia-reading system 10, or both.

The analysis by the verification subsystem 40 regarding the manner in which the indicia information was acquired may also include an analysis of image-capturing subsystem settings. In particular, where an image-capturing subsystem 20A is used, the verification subsystem 40 may evaluate the settings of the imager 31 (e.g., camera settings) such as lighting (e.g., artificial lighting such as flash), focus, and exposure time. If, for example, the verification subsystem 40 detects that the digital image of the indicia suffers from motion blurring, the verification subsystem 40 may provide user feedback recommending that the imager 21 exposure time be reduced.

The verification subsystem 40 may provide user feedback in a variety of ways. In one configuration, the indicia-reading system 10 may include a speaker for providing user feedback in the form of an aural signal. For example, if the verification subsystem 40 determines that, when the indicia information is captured by the indicia-capturing subsystem 20, the indicia is too far from the indicia-capturing subsystem 20, the verification subsystem may generate a high-pitch aural signal. Similarly, if the indicia is too close to the indicia-capturing subsystem 20, the verification subsystem 40 may generate a low-pitch aural signal, for example.

Alternatively, the indicia-reading system 10 may include a display screen (e.g., LCD screen) for providing user feedback via a graphical cue (e.g., visual cue). The display screen may be integral with the handheld indicia reader (e.g., smartphone configuration) or it may be part of the host device (e.g., a point-of-sale terminal). For example, if the indicia is too far from the indicia-capturing subsystem 20, the verification subsystem 40 may provide user feedback in the form of a sizing indicator, such as a rectangle or other shape indicating the relative size that the indicia should be in the display screen at the time the indicia information is captured. By monitoring the display screen, the user can reposition the indicia-reading device 10 until the indicia fits within the sizing indicator, thereby ensuring that the indicia is at the optimal distance from the indicia-reading device 10. Graphical user feedback may also include text. For example, the verification subsystem 40 may generate text explaining how changing the imager's 21 settings can improve the decoding process, or text describing detected defects in the physical characteristics of the indicia and how those defects should be corrected (e.g., using darker ink).

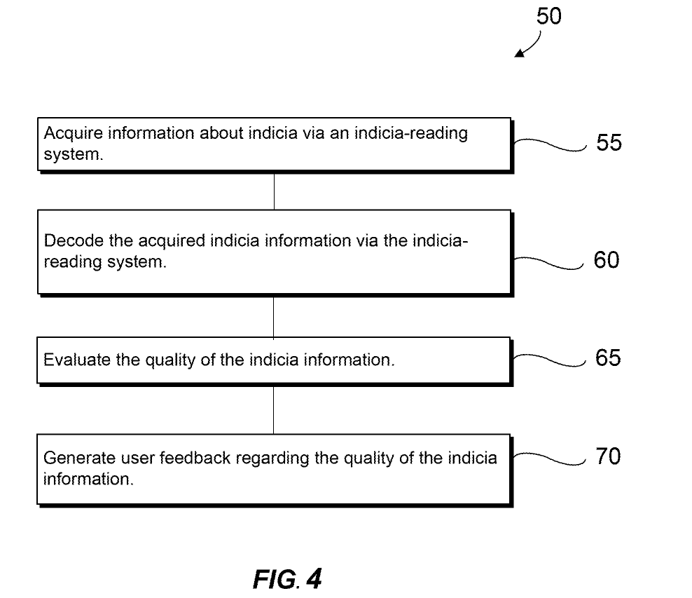

In another aspect, and as illustrated in FIG. 4, the present invention embraces an indicia-verification method 50. Information about indicia is acquired 55. The acquired indicia information is decoded 60. The steps of acquiring and decoding indicia information are usually performed using an indicia reader (e.g., barcode reader). The quality of the indicia information is evaluated 65. Generally speaking, the quality of the indicia information is influenced by the positioning and/or orientation of the indicia when the indicia information is acquired (e.g., when the indicia is imaged or scanned), and/or the physical characteristics of the indicia itself. Based upon the evaluated quality of the indicia information, user feedback regarding the quality of the indicia information is generated 70.

### * * *

To supplement the present disclosure, this application incorporates entirely by reference the following patents, patent application publications, and patent applications: U.S. Pat. No. 6,832,725; U.S. Pat. No. 7,128,266; U.S. Pat. No. 7,159,783; U.S. Pat. No. 7,413,127; U.S. Pat. No. 7,726,575; U.S. Pat. No. 8,294,969; U.S. Pat. No. 8,317,105; U.S. Pat. No. 8,322,622; U.S. Pat. No. 8,366,005; U.S. Pat. No. 8,371,507; U.S. Pat. No. 8,376,233; U.S. Pat. No. 8,381,979; U.S. Pat. No. 8,390,909; U.S. Pat. No. 8,408,464; U.S. Pat. No. 8,408,468; U.S. Pat. No. 8,408,469; U.S. Pat. No. 8,424,768; U.S. Pat. No. 8,448,863; U.S. Pat. No. 8,457,013; U.S. Pat. No. 8,459,557; U.S. Pat. No. 8,469,272; U.S. Pat. No. 8,474,712; U.S. Pat. No. 8,479,992; U.S. Pat. No. 8,490,877; U.S. Pat. No. 8,517,271; U.S. Pat. No. 8,523,076; U.S. Pat. No. 8,528,819; U.S. Pat. No. 8,544,737; U.S. Pat. No. 8,548,242; U.S. Pat. No. 8,548,420; U.S. Pat. No. 8,550,335; U.S. Pat. No. 8,550,354; U.S. Pat. No. 8,550,357; U.S. Pat. No. 8,556,174; U.S. Pat. No. 8,556,176; U.S. Pat. No. 8,556,177; U.S. Pat. No. 8,559,767; U.S. Pat. No. 8,559,957; U.S. Pat. No. 8,561,895; U.S. Pat. No. 8,561,903; U.S. Pat. No. 8,561,905; U.S. Pat. No. 8,565,107; U.S. Pat. No. 8,571,307; U.S. Pat. No. 8,579,200; U.S. Pat. No. 8,583,924; U.S. Pat. No. 8,584,945; U.S. Pat. No. 8,587,595; U.S. Pat. No. 8,587,697; U.S. Pat. No. 8,588,869; U.S. Pat. No. 8,590,789; U.S. Pat. No. 8,593,539; U.S. Pat. No. 8,596,542; U.S. Pat. No. 8,596,543; U.S. Pat. No. 8,599,271; U.S. Pat. No. 8,600,158; U.S. Pat. No. 8,600,167; U.S. Patent Application Publication No. 2009/0134221; U.S. Patent Application Publication No. 2010/0177080; U.S. Patent Application Publication No. 2010/0177076; U.S. Patent Application Publication No. 2010/0177707; U.S. Patent Application Publication No. 2010/0177749; U.S. Patent Application Publication No. 2010/0225757; U.S. Patent Application Publication No. 2011/0169999; U.S. Patent Application Publication No. 2012/0111946; U.S. Patent Application Publication No. 2012/0168511; U.S. Patent Application Publication No. 2012/0168512; U.S. Patent Application Publication No. 2012/0193407; U.S. Patent Application Publication No. 2012/0193423; U.S. Patent Application Publication No. 2012/0203647; U.S. Patent Application Publication No. 2012/0223141; U.S. Patent Application Publication No. 2012/0228382; U.S. Patent Application Publication No. 2012/0248188; U.S. Patent Application Publication No. 2013/0043312; U.S. Patent Application Publication No. 2013/0056285; U.S. Patent Application Publication No. 2013/0068840; U.S. Patent Application Publication No. 2013/0070322; U.S. Patent Application Publication No. 2013/0075168; U.S. Patent Application Publication No. 2013/0082104; U.S. Patent Application Publication No. 2013/0175343; U.S. Patent Application Publication No. 2013/0256418; U.S. Patent Application Publication No. 2013/0270346; U.S. Patent Application Publication No. 2013/0278425; U.S. Patent Application Publication No. 2013/0284801; U.S. Patent Application Publication No. 2013/0287258; U.S. Patent Application Publication No. 2013/0292474; U.S. Patent Application Publication No. 2013/0292475; U.S. patent application Ser. No. 13/347,193 for a Hybrid-Type Bioptical Laser Scanning And Digital Imaging System Employing Digital Imager With Field Of View Overlapping Field Of Field Of Laser Scanning Subsystem, filed Jan. 10, 2012 (Kearney et al.); U.S. patent application Ser. No. 13/367,047 for Laser Scanning Modules Embodying Silicone Scan Element With Torsional Hinges, filed Feb. 6, 2012 (Feng et al.); U.S. patent application Ser. No. 13/367,978 for a Laser Scanning Module Employing An Elastomeric U-Hinge Based Laser Scanning Assembly, filed Feb. 7, 2012 (Feng et al.); U.S. patent application Ser. No. 13/400,748 for a Laser Scanning Bar Code Symbol Reading System Having Intelligent Scan Sweep Angle Adjustment Capabilities Over The Working Range Of The System For Optimized Bar Code Symbol Reading Performance, filed Feb. 21, 2012 (Wilz); U.S. patent application Ser. No. 13/471,973 for Terminals and Methods for Dimensioning Objects, filed May 15, 2012; U.S. patent application Ser. No. 13/492,883 for a Laser Scanning Module With Rotatably Adjustable Laser Scanning Assembly, filed Jun. 10, 2012 (Hennick et al.); U.S. patent application Ser. No. 13/736,139 for an Electronic Device Enclosure, filed Jan. 8, 2013 (Chaney); U.S. patent application Ser. No. 13/750,304 for Measuring Object Dimensions Using Mobile Computer, filed Jan. 25, 2013; U.S. patent application Ser. No. 13/771,508 for an Optical Redirection Adapter, filed Feb. 20, 2013 (Anderson); U.S. patent application Ser. No. 13/780,158 for a Distraction Avoidance System, filed Feb. 28, 2013 (Sauerwein); U.S. patent application Ser. No. 13/780,196 for Android Bound Service Camera Initialization, filed Feb. 28, 2013 (Todeschini et al.); U.S. patent application Ser. No. 13/780,271 for a Vehicle Computer System with Transparent Display, filed Feb. 28, 2013 (Fitch et al.); U.S. patent application Ser. No. 13/780,356 for a Mobile Device Having Object-Identification Interface, filed Feb. 28, 2013 (Samek et al.); U.S. patent application Ser. No. 13/784,933 for an Integrated Dimensioning and Weighing System, filed Mar. 5, 2013 (McCloskey et al.); U.S. patent application Ser. No. 13/785,177 for a Dimensioning System, filed Mar. 5, 2013 (McCloskey et al.); U.S. patent application Ser. No. 13/792,322 for a Replaceable Connector, filed Mar. 11, 2013 (Skvoretz); U.S. patent application Ser. No. 13/852,097 for a System and Method for Capturing and Preserving Vehicle Event Data, filed Mar. 28, 2013 (Barker et al.); U.S. patent application Ser. No. 13/885,218 for a Indicia Encoding System with Integrated Purchase and Payment Information, filed Oct. 6, 2013 (Liu et al.); U.S. patent application Ser. No. 13/895,616 for a Laser Scanning Code Symbol Reading System Employing Multi-Channel Scan Data Signal Processing with Synchronized Digital Gain Control (SDGC) for Full Range Scanning, filed May 16, 2013 (Xian et al.); U.S. patent application Ser. No. 13/895,846 for a Method of Programming a Symbol Reading System, filed Apr. 10, 2013 (Corcoran); U.S. patent application Ser. No. 13/897,512 for a Laser Scanning Code Symbol Reading System Providing Improved Control over the Length and Intensity Characteristics of a Laser Scan Line Projected Therefrom Using Laser Source Blanking Control, filed May 20, 2013 (Brady et al.); U.S. patent application Ser. No. 13/897,634 for a Laser Scanning Code Symbol Reading System Employing Programmable Decode Time-Window Filtering, filed May 20, 2013 (Wilz, Sr. et al.); U.S. patent application Ser. No. 13/902,110 for a System and Method for Display of Information Using a Vehicle-Mount Computer, filed May 24, 2013 (Hollifield); U.S. patent application Ser. No. 13/902,144, for a System and Method for Display of Information Using a Vehicle-Mount Computer, filed May 24, 2013 (Chamberlin); U.S. patent application Ser. No. 13/902,242 for a System For Providing A Continuous Communication Link With A Symbol Reading Device, filed May 24, 2013 (Smith et al.); U.S. patent application Ser. No. 13/912,262 for a Method of Error Correction for 3D Imaging Device, filed Jun. 7, 2013 (Jovanovski et al.); U.S. patent application Ser. No. 13/912,702 for a System and Method for Reading Code Symbols at Long Range Using Source Power Control, filed Jun. 7, 2013 (Xian et al.); U.S. patent application Ser. No. 13/922,339 for a System and Method for Reading Code Symbols Using a Variable Field of View, filed Jun. 20, 2013 (Xian et al.); U.S. patent application Ser. No. 13/927,398 for a Code Symbol Reading System Having Adaptive Autofocus, filed Jun. 26, 2013 (Todeschini); U.S. patent application Ser. No. 13/930,913 for a Mobile Device Having an Improved User Interface for Reading Code Symbols, filed Jun. 28, 2013 (Gelay et al.); U.S. patent application Ser. No. 13/933,415 for an Electronic Device Case, filed Jul. 2, 2013 (London et al.); U.S. patent application Ser. No. 13/947,296 for a System and Method for Selectively Reading Code Symbols, filed Jul. 22, 2013 (Rueblinger et al.); U.S. patent application Ser. No. 13/950,544 for a Code Symbol Reading System Having Adjustable Object Detection, filed Jul. 25, 2013 (Jiang); U.S. patent application Ser. No. 13/961,408 for a Method for Manufacturing Laser Scanners, filed Aug. 7, 2013 (Saber et al.); U.S. patent application Ser. No. 13/973,315 for a Symbol Reading System Having Predictive Diagnostics, filed Aug. 22, 2013 (Nahill et al.); U.S. patent application Ser. No. 13/973,354 for a Pairing Method for Wireless Scanner via RFID, filed Aug. 22, 2013 (Wu et al.); U.S. patent application Ser. No. 13/974,374 for Authenticating Parcel Consignees with Indicia Decoding Devices, filed Aug. 23, 2013 (Ye et al.); U.S. patent application Ser. No. 14/018,729 for a Method for Operating a Laser Scanner, filed Sep. 5, 2013 (Feng et al.); U.S. patent application Ser. No. 14/019,616 for a Device Having Light Source to Reduce Surface Pathogens, filed Sep. 6, 2013 (Todeschini); U.S. patent application Ser. No. 14/023,762 for a Handheld Indicia Reader Having Locking Endcap, filed Sep. 11, 2013 (Gannon); and U.S. patent application Ser. No. 14/035,474 for Augmented-Reality Signature Capture, filed Sep. 24, 2013 (Todeschini); U.S. patent application Ser. No. 14/058,721 for a Terminal Configurable for Use Within an Unknown Regulatory Domain, filed Oct. 21, 2013 (Pease et al.); U.S. patent application Ser. No. 14/035,474 for Augmented-Reality Signature Capture, filed Sep. 24, 2013 (Todeschini); U.S. patent application Ser. No. 14/050,515 for Hybrid-Type Bioptical, filed Oct. 10, 2013 (Edmonds et al.); U.S. patent application Ser. No. 14/055,234 for Dimensioning System, filed Oct. 16, 2013 (Fletcher); U.S. patent application Ser. No. 14/055,353 for Dimensioning System, filed Oct. 16, 2013 (Giordano et al.); U.S. patent application Ser. No. 14/050,675 for Apparatus for Displaying Bar Codes from Light Emitting Display Surfaces, filed Oct. 10, 2013 (Horn et al.); U.S. patent application Ser. No. 14/053,314 for Indicia Reader, filed Oct. 14, 2013 (Huck); U.S. patent application Ser. No. 14/058,762 for Terminal Including Imaging Assembly, filed Oct. 21, 2013 (Gomez et al.); U.S. patent application Ser. No. 14/058,831 for System Operative to Adaptively Select an Image Sensor for Decodable Indicia Reading, filed Oct. 21, 2013 (Sauerwein); U.S. patent application Ser. No. 14/062,239 for Chip on Board Based Highly Integrated Imager, filed Oct. 24, 2013 (Toa et al.); U.S. patent application Ser. No. 14/065,768 for Hybrid System and Method for Reading Indicia, filed Oct. 29, 2013 (Meier et al.); U.S. patent application Ser. No. 14/074,746 for Self-Checkout Shopping System, filed Nov. 8, 2013 (Hejl et al.) U.S. patent application Ser. No. 14/074,787 for Method and System for Configuring Mobile Devices via NFC Technology, filed Nov. 8, 2013 (Smith et al.).

### * * *

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. An indicia-reading system, comprising:
an indicia-capturing subsystem for acquiring information about indicia within the indicia-capturing subsystem's field of view;
an indicia-decoding subsystem configured for decoding indicia information; and
a verification subsystem for (i) evaluating the quality of the indicia information and (ii) generating user feedback regarding the quality of the indicia information.

2. The indicia-reading system according to claim 1, wherein the user feedback comprises information about the physical characteristics of the indicia.

3. The indicia-reading system according to claim 1, wherein the user feedback comprises a recommendation regarding positioning of the indicia-reading system vis-à-vis the indicia.

4. The indicia-reading system according to claim 1, wherein the indicia-capturing subsystem is configured to acquire information about barcode symbols within the indicia-capturing subsystem's field of view.

5. The indicia-reading system according to claim 1, wherein the indicia-capturing subsystem is an imaging subsystem for capturing images within the imaging subsystem's field of view.

6. The indicia-reading system according to claim 1, wherein the indicia information comprises a digital image of indicia.

7. The indicia-reading system according to claim 1, wherein the indicia-capturing subsystem is a laser scanning subsystem for scanning indicia within the laser scanning subsystem's field of view.

8. The indicia-reading system according to claim 1, wherein the indicia-capturing subsystem comprises a laser source for projecting laser light toward indicia, and a photodiode for collecting laser light reflected from the indicia.

9. The indicia-reading system according to claim 1, wherein the indicia-decoding subsystem comprises a signal processor.

10. The indicia-reading system according to claim 1, wherein the verification subsystem comprises a speaker for providing user feedback in the form of an aural signal.

11. The indicia-reading system according to claim 1, wherein the verification subsystem comprises a display screen for providing user feedback via a graphical cue.

12. An indicia-validation method, comprising:
acquiring information about indicia via an indicia-reading system;
decoding the acquired indicia information via the indicia-reading system;
evaluating the quality of the indicia information; and
generating user feedback regarding the quality of the indicia information.

13. The method according to claim 12, wherein the user feedback comprises information about the physical characteristics of the indicia.

14. The method according to claim 12, wherein the user feedback comprises information about the density of the indicia.

15. The method according to claim 12, wherein the user feedback comprises information about the print quality of the indicia.

16. The method according to claim 12, wherein the user feedback comprises a recommendation regarding the positioning of the indicia with respect to the indicia-reading system.

17. The method according to claim 12, wherein the user feedback comprises a recommendation regarding orientation of the indicia with respect to the indicia-reading system.

18. The method according to claim 12, wherein the user feedback comprises an aural signal.

19. The method according to claim 12, wherein the user feedback comprises a graphical cue.

20. The method according to claim 12, wherein the indicia information comprises a digital image of the indicia.
